(19) United States
(12) Patent Application Publication
(10) Pub. No.: US 2021/0370532 A1
(43) Pub. Date: Dec. 2, 2021

(54) SCRAPER

(71) Applicants: HANGZHOU UNITED TOOLS CO., LTD., Hangzhou City, Zhejiang Province (CN); HANGZHOU GREAT STAR INDUSTRIAL CO., LTD., Hangzhou City, Zhejiang Province (CN)

(72) Inventor: Yueming Li, Hangzhou City, Zhejiang Province (CN)

(73) Assignees: HANGZHOU UNITED TOOLS CO., LTD., Hangzhou City, Zhejiang Province (CN); HANGZHOU GREAT STAR INDUSTRIAL CO., LTD., Hangzhou City, Zhejiang Province (CN)

(21) Appl. No.: 16/620,309

(22) PCT Filed: Feb. 20, 2019
(86) PCT No.: PCT/CN2019/075554

§ 371 Date: Dec. 6, 2019

(51) Int. Cl. B26B 9/02; A47L 13/08; A47L 13/022

(52) U.S. Cl. CPC B26B 9/02; A47L 13/022; A47L 13/08

(57) ABSTRACT

Disclosed is a scraper, a blade has at least one cutting edge, at least one of which is a multi-arc cutting edge, and the multi-arc cutting edge is a variable diameter cutting edge. In the present invention, the cutting edge of the blade is designed as a multi-arc cutting edge, which overcomes the problem in the prior art that a planar edge cannot operate in an uneven position, and the design of the multi-arc cutting edge widens the application range of a single-arc edge, thereby achieving a better cleaning effect.

### TECHNICAL FIELD

The present invention relates to the field of mechanical manufacturing tools, and in particular to a scraper.

### BACKGROUND ART

The common scraper has a planar edge, and when removing dirt from the surface of a piece of equipment, the cleaning effect is poor for an uneven place on the surface. In addition, as the scraper is used increasingly, the cutting edge of the blade will wear down and the blade needs to be replaced frequently. However, the blade of the existing scraper is connected to a handle via a compression rod, for most of blades, the compression rod needs to be completely removed to rotate or replace the blade, which undoubtedly increases the complexity.

Accordingly, those skilled in the art devote themselves to developing a cleaning tool that can quickly replace a blade and is suitable for an uneven surface.

### SUMMARY OF THE INVENTION

In view of the above-mentioned drawbacks of the prior art, the technical problems to be solved by the present invention are how to replace a blade without completely removing a compression rod, and to be able to clean an uneven surface.

To achieve the above objects, the present invention provides a scraper which comprises a blade, the blade has at least a cutting edge, and at least one of which is a multi-arc cutting edge.

Further, the multi-arc cutting edge is a variable diameter cutting edge.

Further, the multi-arc cutting edge is a double-arc cutting edge.

Further, at least one of the cutting edges is a planar cutting edge.

Further, a main body of the blade is a polygon, and the cutting edge is provided on each side.

Further, the polygon is a triangle, a quadrangle or a pentagon.

Further, a handle and a compression rod are comprised, wherein the blade comprises a detaching hole, and a first end of the compression rod can come off the detaching hole, so that the blade can be detached.

Further, the blade comprises a plurality of positioning holes, the handle comprises bumps cooperating with the positioning holes, and the blade is disposed to cooperate with the bumps on the handle via the positioning holes so as to be fixed to the handle.

Further, an actuation portion and an elastic member are further comprised, wherein the first end of the compression rod compresses the blade against the handle, and a second end of the compression rod is connected to the actuation portion; and the actuation portion can drive the compression rod to move in an axial direction of the compression rod, and the elastic member is disposed to apply an elastic restoring force to the blade, such that the blade can move along with the first end of the compression rod.

Further, the second end of the compression rod is threadedly connected to the actuation portion to drive the compression rod to move in the axial direction of the compression rod.

Further, comprised is a limiting member which is sheathed on the second end of the compression rod, wherein the actuation portion is internally provided with a fixing structure cooperating with the limiting member, and an actuation stroke is provided between the limiting member and the fixing structure.

Further, an elastic device is disposed between the actuation portion and the handle, the elastic device is sheathed on the compression rod, and the elastic device is disposed to apply an elastic restoring force to the actuation portion to drive the compression rod to move in the axial direction of the compression rod.

Further, comprised is a catching sleeve which is sheathed on the compression rod, wherein the elastic member is placed in the catching sleeve, and the elastic member is disposed to apply the elastic restoring force to the catching sleeve such that the catching sleeve pushes the blade to move along with the first end of the compression rod. The catching sleeve is provided with a rib, the handle is internally provided with a catching groove, and the rib cooperates with the catching groove to prevent the catching sleeve from coming off the handle.

In the present invention, the cutting edge of the blade is designed as a multi-arc cutting edge, which overcomes the problem that a planar edge cannot operate in an uneven position in the prior art, and the design of the multi-arc cutting edge widens the application range of a single-arc edge, thereby achieving a better cleaning effect.

In the existing scraper, it is not only time-consuming and laborious in replacing the blade but also needs to completely remove the compression rod, while in the scraper of the present invention, the blade can come off the handle when the blade is replaced due to the presence of the elastic member, and because the limiting member is designed therein, in the process of replacing the blade, the blade can be replaced without completely removing the compression rod, which is convenient to use.

The rib of the catching sleeve of the present invention cooperates with the catching groove in the through hole to prevent the catching sleeve from falling out of the handle.

The concept, specific structure and resulting technical effect of the present invention are further described below in conjunction with the drawings to fully understand the object, features and effects of the present invention.

### BRIEF DESCRIPTION OF THE DRAWINGS

FIG. 1 is a schematic structural view of a blade according to a preferred embodiment of the present invention;

FIG. 2 is a schematic view showing the arrangement of the positions of a multi-arc edge and a planar edge according to a preferred embodiment of the present invention;

FIG. 3 is a perspective structural view of a schematic scraper with a polygonal blade according to a preferred embodiment of the present invention;

FIG. 4 is a schematic structural view of a scraper according to a preferred embodiment of the present invention;

FIG. 5 is an exploded view of a scraper according to a preferred embodiment of the present invention;

FIG. 6 is a cross-sectional view of a scraper according to a preferred embodiment of the present invention;

FIG. 7 is a schematic view of a snap spring instead of a fixing sleeve according to a preferred embodiment of the present invention;

FIG. 8 is a cross-sectional view of a snap spring instead of a fixing sleeve according to a preferred embodiment of the present invention;

FIG. 9 is a schematic structural view of a catching sleeve according to a preferred embodiment of the present invention;

FIG. 10 is a schematic structural view of a catching sleeve according to another preferred embodiment of the present invention;

FIG. 11 is a schematic view showing the cooperation of a catching sleeve and a through hole according to another preferred embodiment of the present invention.

100. Blade, 101. Screw, 102. Blade, 10201. Water drop hole, 10202. Positioning hole, 10203. Planar cutting edge, 10204. Multi-arc cutting edge, 103. Handle, 10301. Through hole, 10302. Catching groove, 10303. Sliding groove, 10304. Bump, 104. Actuation portion, 10401. Snap, 105. Shaft sleeve, 106. Fixing sleeve, 10601. Fixing sleeve mounting preformed hole, 107. Actuation stroke, 208 and 108. Catching sleeve, 10801. Rib, 109. Spring member, 1010. Washer, 206. Snap spring, 20601. Snap spring mounting preformed hole.

### DETAILED DESCRIPTION OF EMBODIMENTS

Preferred embodiments of the present invention are described below with reference to the drawings of the description to make the technical contents clearer and easier to understand. The present invention can be embodied in various forms of embodiments, and the scope of protection of the present invention is not limited to the embodiments mentioned herein.

In the drawings, the same reference numeral indicates components having the same structure, and similar reference numerals indicate assemblies having similar structures or functions throughout. The size and thickness of each assembly shown in the figures are shown arbitrarily, and the present invention does not define the size and thickness of each assembly. In order to make the illustration clearer, the thickness of the component in some places of the figures is appropriately exaggerated. “Second end” and “upper end” stated in the present invention are the end away from a blade, “first end” and “lower end” are the end close to the blade, and “moving up” means that a second end of a compression rod moves towards a second end of an actuation portion, and “moving down” refers to the movement of the second end of the compression rod away from the second end of the actuation portion.

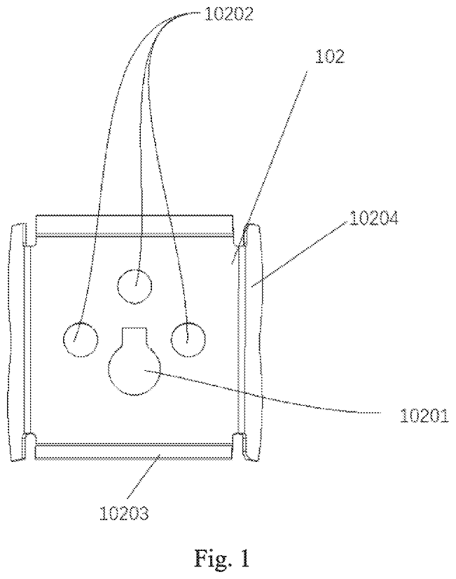

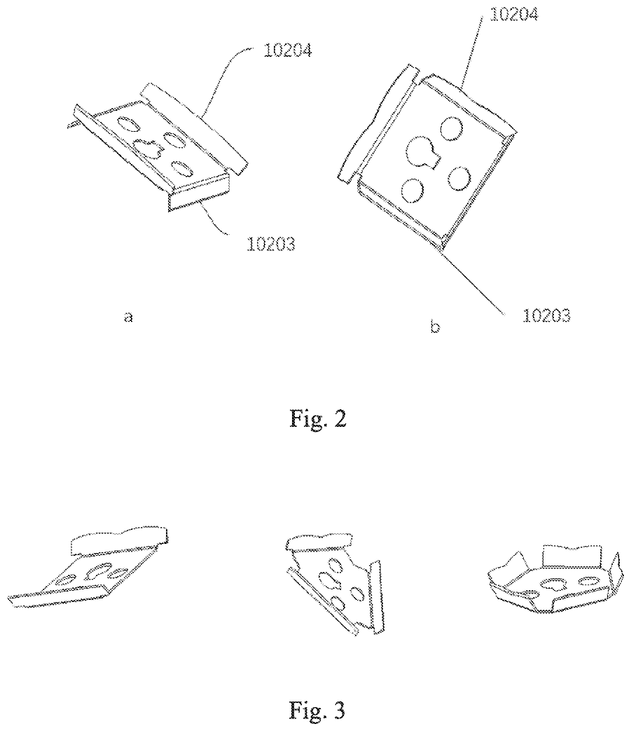

As shown in FIGS. 1-3, a blade 102 has at least one cutting edge disposed to be curved relative to a main body of the blade 102, and at least one of the cutting edges is a multi-arc cutting edge which is a variable diameter cutting edge. Referring to FIGS. 2 and 3, the cutting edges of the blade 102 are provided with a pair of planar cutting edges 10203 and a pair of multi-arc cutting edges 10204. The planar cutting edges 10203 are disposed opposite the multi-arc cutting edges 10204 (see FIG. 2a) or adjacent to same (see FIG. 2b). The orientation of the pair of planar cutting edges 10203 and the orientation of the pair of multi-arc cutting edges 10204 are opposite with respect to the main body of the blade 102. The blade 102 has three positioning holes 10202 and one water drop hole 10201, and these three positioning holes 10202 respectively cooperate with bumps 10304 on the handle 103 such that the blade 102 is fixed to the handle 103. A first mounting hole of the water drop hole 10201 can mount a screw 101 on the blade 102, and a second mounting hole thereof cooperates with the bump 10304 on the handle 103 such that the blade 102 is fixed to the handle 103. The number of the positioning holes 10202 is not limited to three. It should be understood that in order to increase the use of the blade 102 at different angles, the blade 102 is not limited to a quadrangular arrangement, and may be provided as a polygon such as a triangle or a pentagon, each side of which is provided with a cutting edge, and the orientation among the cutting edges may be opposite and may also be the same, see FIG. 3.

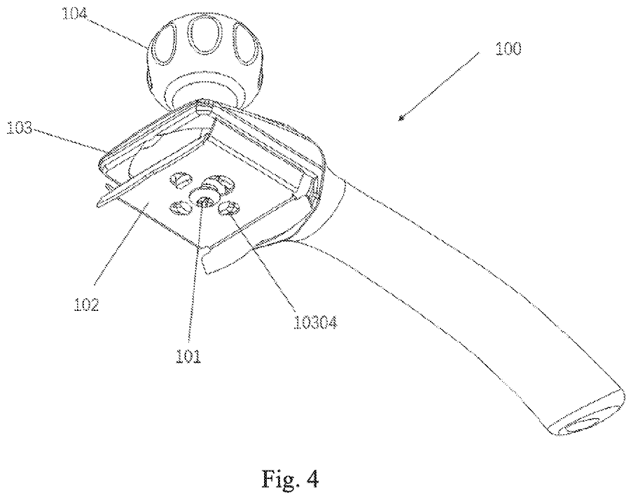

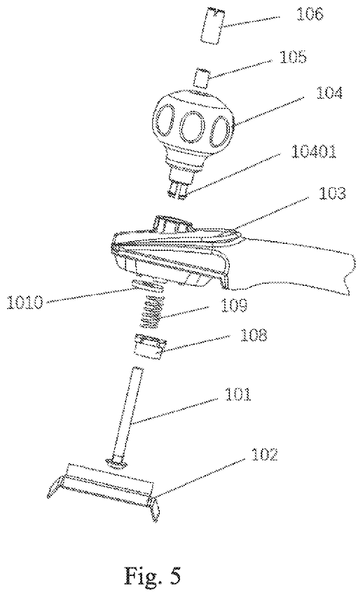

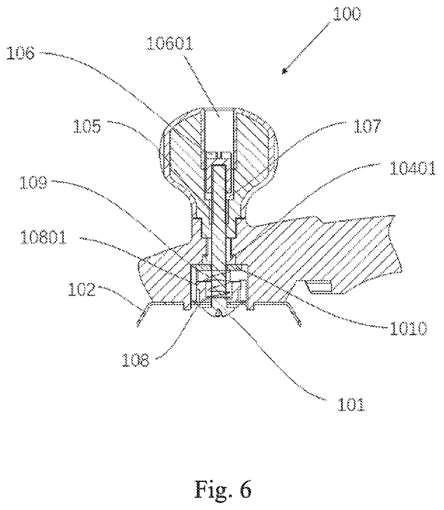

In an embodiment according to the present invention shown in FIGS. 4-6, 100 refers to a scraper. The screw 101 passes through the water drop hole 10201 in the blade 102 and through the handle 103 to be threadedly connected to a shaft sleeve 105 inside an actuation portion 104. Here, the shaft sleeve 105 is embedded into and fixed to the actuation portion 104. Similarly, the actuation portion 104 may be directly threadedly connected to the screw 101. Here, the screw 101 is a compression rod. Similarly, the compression rod can be a bolt or a stud. The fixing sleeve 106 is sheathed on a second end of the screw 101 via a fixing sleeve mounting preformed hole 10601. Here, the fixing sleeve 106 is a limiting member. An actuation stroke 107 is provided between the fixing sleeve 106 and the shaft sleeve 105, see FIG. 6. The actuation portion 104 is screwed and drives the shaft sleeve 105 to rotate relative to the screw 101. When the screw 101 moves down until the blade 102 can be rotated or removed, a lower end of the fixing sleeve 106 comes into contact with a fixing structure, thereby preventing the screw 101 from coming off the handle 103. When the screw 101 moves up until the blade 102 is fixed to the handle 103, the actuation stroke 107 by the screwing of the actuation portion 104 is provided between the lower end of the fixing sleeve 106 and the fixing structure. When the screw 101 moves up until the blade 102 is fixed to the handle 103, an elastic member 109 is in a compressed state. When the screw 101 moves down until the blade 102 can be rotated or removed, the elastic member 109 applies an elastic restoring force to the blade 102, thereby pushing the blade 102 such that same comes off the handle.

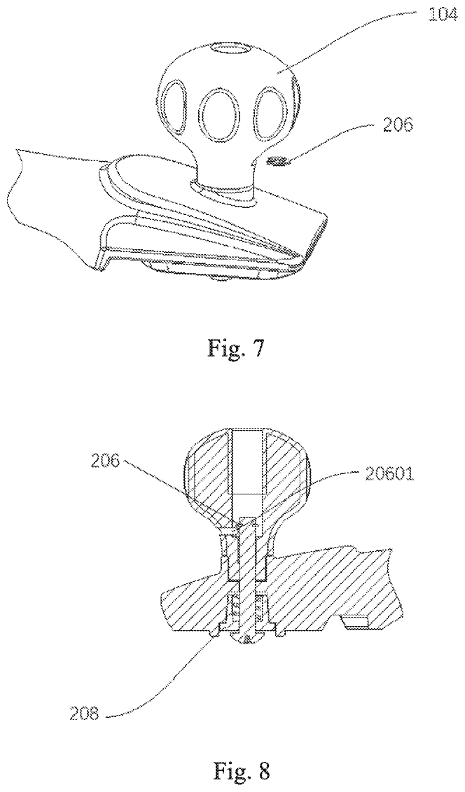

Similarly, a snap spring 206 replaces the fixing sleeve 106. The snap spring 206 is sheathed on the second end of the screw 101 via a snap spring mounting preformed hole 20601, see FIGS. 7 and 8.

In other embodiments, a pressing structure is employed in place of the structure that creates the threaded connection. An elastic device is disposed between the actuation portion 104 and the handle 103, and the elastic device is sheathed on the compression rod 101. The actuation portion 104 is pressed such that the compression rod 101 moves down, at which time the elastic device is in a compressed state. When the blade 102 is rotated or installed, the elastic device applies an elastic restoring force to the actuation portion 104 to drive the compression rod 101 to move up.

A lower end of the actuation portion 104 is provided with a snap 10401, and after the actuation portion 104 is inserted into a through hole 10301 of the handle 103, an elastic arm of the snap 10401 is deformed and pressed into the through hole 10301 of the handle 103. The snap 10401 is designed to reinforce the connection between the actuation portion 104 and the handle 103. In the present invention, the principle of connection between the actuation portion 104 and the handle 103 lies in that the screw 101 penetrates the through hole 10301 of the handle 103 and is directly or indirectly connected to the actuation portion 104.

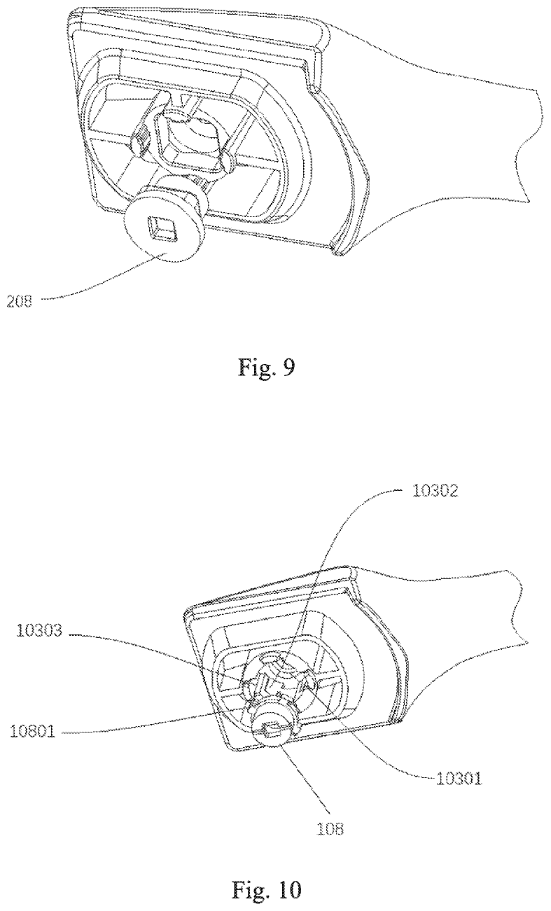

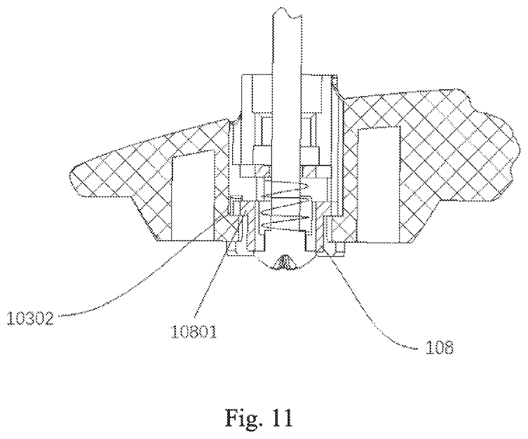

As shown in FIGS. 9 and 10, a catching sleeve 208 is placed in the through hole 10301 of the handle 103. The catching sleeve 208 is sheathed on the screw 101. The elastic member 109 is placed in the catching sleeve 208. A second end of the elastic member 109 is fixedly connected to the handle 103 or a washer 1010. Here, the washer 1010 is located between the handle 103 and the elastic member 109. A lower end of the elastic member 109 is in contact with the bottom of the catching sleeve 208. The bottom of the catching sleeve 208 is in direct contact with the blade 102. The catching sleeve 208, under the elastic restoring force of the elastic member 109, pushes the blade 102 such that same comes off the handle 103. Preferably, see FIGS. 10 and 11, an inner wall of the through hole 10301 of the handle 103 is provided with a catching groove 10302 and a sliding groove 10303. The catching sleeve 108 is placed in the through hole 10301. The catching groove 10302 cooperates with a rib 10801 on the catching sleeve 108 to prevent the catching sleeve 108 from falling off a catching place along with the blade 102 as the catching sleeve pushes the blade 102. The catching sleeve 108 slides in the sliding groove 10303. The screw 101 penetrates the catching sleeve 108 and the elastic member 109. When the screw 101 moves up until the blade 102 is fixed to the handle 103, the elastic member 109 is in a compressed state. When the screw 101 moves down until the blade 102 can be rotated or removed, the elastic member 109 exerts a pushing force on the blade 102 by the elastic restoring force, causing that the catching sleeve 108 pushes the blade 102 such that same comes off the catching place, thereby easily rotating or replacing the blade 102.

In other embodiments, the lower end of the elastic member 109 is in direct contact with the blade.

It is to be noted that the outer diameter of the first end of the screw 101 is larger than the hole diameter of the first mounting hole and smaller than the hole diameter of the second mounting hole of the water droplet hole 10201. When the actuation portion 104 is screwed or pressed, due to the presence of the limiting member, the screw 101 is prevented from completely coming off the handle 103. At this time, the catching sleeve 108, under the elastic restoring force, pushes the blade 102 such that same comes off the catching place. If it is necessary to replace the cutting edge, the blade 102 is rotated by an appropriate angle with the screw 101 as an axis to replace the cutting edge. If the blade is to be replaced, the blade 102 is pulled such that the screw 101 moves from the first mounting hole to the second mounting hole of the water drop hole 10201. At this time, the blade 102 is removed and then turned over to use the cutting edge of the other side or to be replaced with a new one. When the blade 102 is mounted, the second mounting hole of the water drop hole 10201 is sheathed outside the screw 101, and the blade 102 is pulled such that the screw 101 moves from the second mounting hole of the water drop hole 10201 to the first mounting hole of the water drop hole 10201. The actuation portion 104 is screwed or pressed such that the screw 101 moves up until the blade 102 is fixed to the handle 103, being convenient to use.

In other embodiments, the screw 101 is replaced with a bolt or stud, with a nut as a mating part. The outer diameter of the nut is larger than the hole diameter of the first mounting hole and smaller than the hole diameter of the second mounting hole of the water drop hole 10201.

The specific preferred embodiment of the present invention is described in detail as above. It should be appreciated that a person of ordinary skill in the art would be able to make modifications and variations in accordance with the concept of the present invention without involving any inventive effort. Therefore, any technical solution that can be obtained by a person skilled in the art by means of logical analysis, reasoning or limited trials on the basis of the prior art and according to the concept of the present invention should be included within the scope of protection of the claims.

1. A scraper, characterized by comprising a blade, the blade having at least a cutting edge, and at least one of which being a multi-arc cutting edge.

2. The scraper of claim 1, wherein the multi-arc cutting edge is a variable diameter cutting edge.

3. The scraper of claim 1, wherein the multi-arc cutting edge is a double-arc cutting edge.

4. The scraper of claim 1, wherein at least one of the cutting edges is a planar cutting edge.

5. The scraper of claim 1, wherein a main body of the blade is a polygon, and the cutting edge is provided on each side.

6. The scraper of claim 5, wherein the polygon is a triangle, a quadrangle or a pentagon.

7. The scraper of claim 1, comprising a handle and a compression rod, wherein the blade comprises a detaching hole, and a first end of the compression rod can come off the detaching hole, so that the blade can be detached.

8. The scraper of claim 7, wherein the blade comprises a plurality of positioning holes, the handle comprises bumps cooperating with the positioning holes, and the blade is disposed to cooperate with the bumps on the handle via the positioning holes so as to be fixed to the handle.

9. The scraper of claim 7, further comprising an actuation portion and an elastic member, wherein the first end of the compression rod compresses the blade against the handle, and a second end of the compression rod is connected to the actuation portion; and the actuation portion can drive the compression rod to move in an axial direction of the compression rod, and the elastic member is disposed to apply an elastic restoring force to the blade, such that the blade can move along with the first end of the compression rod.

10. The scraper of claim 9, wherein the second end of the compression rod is threadedly connected to the actuation portion to drive the compression rod to move in the axial direction of the compression rod.

11. The scraper of claim 10, comprising a limiting member which is sheathed on the second end of the compression rod, wherein the actuation portion is internally provided with a fixing structure cooperating with the limiting member, and an actuation stroke is provided between the limiting member and the fixing structure.

12. The scraper of claim 9, wherein an elastic device is disposed between the actuation portion and the handle, the elastic device is sheathed on the compression rod, and the elastic device is disposed to apply an elastic restoring force to the actuation portion to drive the compression rod to move in the axial direction of the compression rod.

13. The scraper of claim 7, comprising a catching sleeve which is sheathed on the compression rod, wherein the elastic member is placed in the catching sleeve, and the elastic member is disposed to apply the elastic restoring force to the catching sleeve such that the catching sleeve pushes the blade to move along with the first end of the compression rod; the catching sleeve is provided with a rib, the handle is internally provided with a catching groove, and the rib cooperates with the catching groove to prevent the catching sleeve from coming off the handle.
